(19) United States
(12) Patent Application Publication
(10) Pub. No.: US 2025/0378249 A1
(43) Pub. Date: Dec. 11, 2025

(54) METHOD FOR SIMULATING AND ANALYSING AT LEAST ONE ELECTRICAL SHORT-CIRCUIT IN AN ELECTRICAL WIRING INTERCONNECTION SYSTEM FOR A VEHICLE, AND METHOD FOR DESIGNING AND MANUFACTURING SUCH A SYSTEM

(71) Applicant: AIRBUS OPERATIONS SAS, Toulouse (FR)

(72) Inventors: Yoann BEILVERT, Toulouse (FR); Cagatay CINAR, Toulouse (FR)

(73) Assignee: AIRBUS OPERATIONS SAS, Toulouse (FR)

(21) Appl. No.: 19/229,924

(22) Filed: Jun. 5, 2025

(30) Foreign Application Priority Data
Jun. 10, 2024 (FR) 2406101

(51) Int. Cl. G06F 30/3308; G06F 30/392; G06F 119/02

(52) U.S. Cl. CPC G06F 30/3308; G06F 30/392; G06F 2119/02

(57) ABSTRACT

A method is proposed for simulating and analysing at least one electrical short-circuit in an electrical wiring interconnection system (EWIS) for a vehicle. The result is a report concerning the safety of the EWIS that lists, for a selected modelled pathway (on which at least one short-circuit is simulated), any functional information associated with one or more modelled pathways affected by the at least one simulated short-circuit. A method is also proposed for designing and manufacturing the EWIS that is based on the simulation and analysis method. This assists the manufacturer in confirming the compliance of the EWIS (notably the spaces between the cable paths, in order to avoid any risks of short-circuits thereon) as early as possible in the process for designing and manufacturing this system.

### TECHNICAL FIELD

The field of the invention is that of electrical wiring interconnection systems (EWIS) for a vehicle.

The present invention relates to a method for simulating and analysing at least one electrical short-circuit in an electrical wiring interconnection system (EWIS) for a vehicle, as well as a method for designing and manufacturing such a system.

### PRIOR ART

In the event that the vehicle is an aircraft, the electrical wiring interconnection system (EWIS) comprises “any wire, cable, cabling device or combination thereof, including terminal devices (i.e., the associated connectors), installed in any area of the aircraft for the purpose of transferring electrical energy, including data and signals between two or more terminal points”.

EWIS allows pilots to be sent information concerning altitude, attitude, flight speed and numerous other data points originating from sensors. EWIS allows instructions from the pilot controls to be sent to the engines, rudders, ailerons and elevators.

The electrical wiring interconnection system (EWIS) in modern aircraft is complex and dense. The compliance regulations issued by the civil aviation authorities stipulate that the cable paths in an EWIS are spaced apart from each other by regulatory minimum distances. Apart from the spatial requirement in aircraft, the task of designing an EWIS with cable paths that are spaced far enough apart to meet the above requirements is difficult.

Therefore, a requirement exists to provide simulation and analysis tools to assist aircraft manufacturers in confirming regulatory compliance as early as possible in the EWIS design and manufacturing process.

### DISCLOSURE OF THE INVENTION

A computer-implemented method is proposed herein for simulating and analysing at least one electrical short-circuit in an electrical wiring interconnection system for a vehicle, comprising:
A) acquiring a 3D digital model of the electrical wiring interconnection system of the vehicle, the digital model comprising modelled pathways that are 3D objects each modelling a physical pathway of one or more cables of the electrical wiring interconnection system, each modelled pathway being associated with one or more functional items of information each modelling a physical signal that passes through said modelled pathway;
B) selecting one of the modelled pathways;
C) simulating at least one electrical short-circuit on the selected modelled pathway; D) determining, for each simulated short-circuit, whether at least one other modelled pathway is affected by the simulated electrical short-circuit; and
E) if at least one other modelled pathway is affected, providing a report concerning the compliance of the electrical wiring interconnection system of the vehicle, the compliance report including, for each simulated short-circuit on the selected modelled pathway, a list including, for the one or for each modelled pathway affected by said simulated electrical short-circuit, the one or more items of functional information associated with said affected modelled pathway, with said compliance report being intended to be used in designing and manufacturing the electrical wiring interconnection system of the vehicle.

Thus, the proposed simulation and analysis method allows a report to be provided concerning the compliance of the electrical wiring interconnection system (EWIS) of the vehicle. This compliance report lists, for a selected modelled pathway (on which at least one short-circuit is simulated), any functional information associated with one or more modelled pathways affected by the at least one simulated short-circuit. This compliance report is intended to be used for designing and manufacturing the electrical wiring interconnection system of the vehicle. Indeed, before the electrical wiring interconnection system is manufactured, the 3D digital model of this system (the model used as a basis for manufacturing this system) can be modified according to this compliance report. For example, each item of functional information listed in the report is reassigned (reassociated) to a modelled pathway that is not affected by the at least one simulated short-circuit. In the real physical world, this is equivalent to passing the physical signal that models this functional information through another physical cable pathway. For more details concerning the use of the result of the simulation and analysis method (i.e., the use of the compliance report), please refer to the following description of the method for designing and manufacturing an electrical wiring interconnection system. In other words, the proposed simulation and analysis method assists the electrical wiring interconnection system manufacturer in confirming regulatory compliance (notably the electrical certification, and more specifically the spacings between the cable paths included in the EWIS) as early as possible in the process for designing and manufacturing this system. The proposed simulation and analysis method also saves time in designing and manufacturing the electrical wiring interconnection system (EWIS).

In a particular embodiment, the vehicle is an aircraft.

According to a particular embodiment, at least one new iteration of operations B) to E) is performed, with a different selected modelled pathway.

According to a particular embodiment, the list also includes, for the selected modelled pathway, the one or more functional items of information associated with the selected modelled pathway.

According to a particular embodiment, simulating a given electrical short-circuit on the selected modelled pathway involves: positioning a risk area encompassing part of the selected modelled pathway; and determining, for the given simulated short-circuit, whether at least one other modelled pathway is affected by said at least one simulated electrical short-circuit, which involves: determining whether at least one other modelled pathway touches or is at least partially contained in the risk area.

According to a particular embodiment, the risk area is a sphere, the centre of which is positioned at the centre of a circular cross-section of the selected modelled pathway, and the radius R of which depends on the following parameters:
r: a radius of a circular cross-section of the selected modelled pathway;
m: a growth margin of the radius r; and
c: a clearance distance that depends on a path type associated with the selected modelled pathway.

According to a particular embodiment, two risk areas consecutively positioned on the selected modelled pathway have an overlap ranging between 40% and 60%.

A method is also proposed for designing and manufacturing an electrical wiring interconnection system for a vehicle, comprising:
a) implementing, by means of a computer, the aforementioned method for simulating and analysing at least one electrical short-circuit, according to any one of the embodiments thereof, by applying it to said electrical wiring interconnection system of said vehicle;
b) if the implementation of the method for simulating and analysing at least one electrical short-circuit results in the provision of at least one report concerning the compliance of the electrical wiring interconnection system of the vehicle, modifying the 3D digital model of the electrical wiring interconnection system of the vehicle according to said at least one compliance report; and
c) manufacturing the electrical wiring interconnection system of the vehicle according to the modified 3D digital model if a modification has been made to the 3D digital model, or according to the unmodified 3D digital model if no modification has been made to the 3D digital model.

Thus, the proposed design and manufacturing method is based on the aforementioned simulation and analysis method, and assists the manufacturer of the electrical wiring interconnection system (EWIS) in confirming the compliance of this system (notably the spacings between the cable paths, to avoid any risks in the event of a short-circuit on one of them) as early as possible in the process for designing and manufacturing this system.

According to a particular embodiment, if a modification has been made to the 3D digital model, a new iteration of operations a) and b) is performed before manufacturing the electrical wiring interconnection system of the vehicle.

A data processing system is also proposed comprising electronic circuitry configured to implement the aforementioned simulation and analysis method, according to any one of the embodiments thereof.

A computer program product is also proposed, comprising instructions that cause a processor to execute the aforementioned simulation and analysis method, according to any one of the embodiments thereof, when said instructions are executed by the processor.

A storage medium storing such instructions is also proposed.

### BRIEF DESCRIPTION OF THE DRAWINGS

The aforementioned features of the invention, as well as others, will become more clearly apparent upon reading the following description of at least one embodiment, with said description being provided with reference to the appended drawings, in which:

FIG. 1 schematically illustrates an example of an algorithm for simulating and analysing at least one electrical short-circuit in an electrical wiring interconnection system for a vehicle, in one embodiment;

FIG. 2 schematically illustrates an example of an algorithm for designing and manufacturing an electrical wiring interconnection system for a vehicle, in one embodiment;

FIG. 3 schematically illustrates an example of part of a 3D digital model of an electrical wiring interconnection system, in which a plurality of short-circuits is simulated on one of the modelled pathways;

FIG. 4 schematically illustrates the overlap of two spheres forming risk areas simulating short-circuits on one of the modelled pathways; and

FIG. 5 schematically illustrates an example of the hardware architecture of a computer (data processing system) implementing the simulation and analysis algorithm of FIG. 1.

### DETAILED DISCLOSURE OF EMBODIMENTS

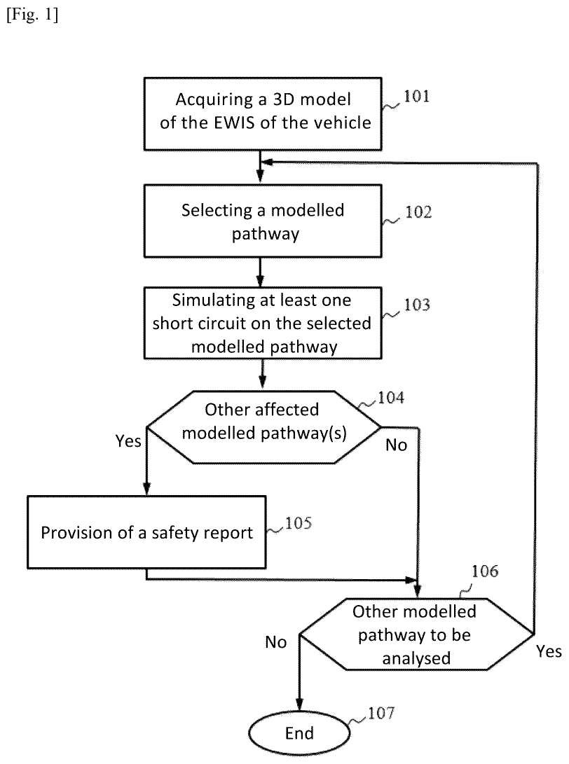

FIG. 1 schematically illustrates an example of an algorithm for simulating and analysing at least one electrical short-circuit in an electrical wiring interconnection system (also called “EWIS” hereafter) for a vehicle, in one embodiment.

This algorithm is executed by a computer (data processing system comprising electronic circuitry), reference 500 in FIG. 5.

In a particular implementation, the vehicle is an aircraft. In a variant, the vehicle is a vessel. In another variant, the vehicle is an automobile.

In a step 101, the system 500 acquires a 3D digital model of the EWIS of the vehicle. The digital model comprises modelled pathways (also called “models of pathways”), which are 3D objects each modelling a physical pathway of the one or more cables of the EWIS. A physical pathway of the one or more cables is defined, for example, as a part of a harness that contains the same group of cables along its entire length and is a pathway between a connection element (for example, a connector) and a branch, between two connection elements, or even between two branches.

Each modelled pathway is associated with one or more functional items of information (also called “Topolink Way”), which each model a physical signal (from first equipment to second equipment) that passes through the physical cable pathway modelled by this modelled pathway.

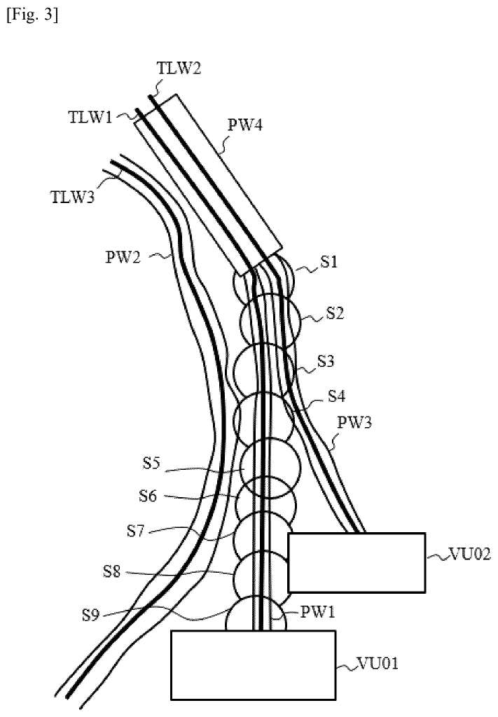

FIG. 3 schematically illustrates an example of part of a 3D digital model of an EWIS. This part comprises four modelled pathways, referenced PW1 to PW4, and two virtual units, referenced VU01 and VU02. The modelled pathway PW1 is associated with the functional information TLW1. The modelled pathway PW2 is associated with the functional information TLW3. The modelled pathway PW3 is associated with the functional information TLW2. The modelled pathway PW4 is associated with the functional information TLW1 and TLW2.

To continue the description of the algorithm in FIG. 1, in a step 102, the system 500 selects one of the modelled pathways. In a particular implementation, this selection occurs via a human-machine interface, allowing a user to choose from a list of modelled pathways and/or from a figure illustrating the modelled pathways.

In a step 103, the system 500 simulates at least one electrical short-circuit on the selected modelled pathway.

In a particular implementation, the simulation of a given electrical short-circuit on the selected modelled pathway involves positioning a risk area encompassing part of the selected modelled pathway.

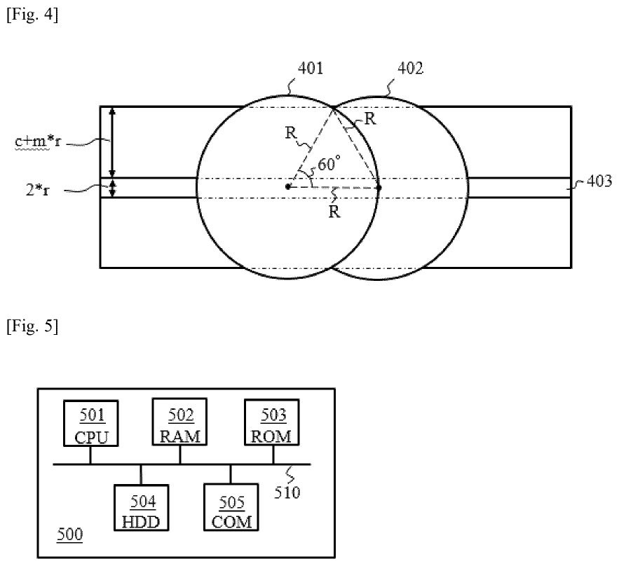

In a particular implementation, illustrated in FIG. 4, the risk area is a sphere that represents the electric arc (see the spheres referenced 401 and 402), the centre of which is positioned at the centre of a circular cross-section of the selected modelled pathway 403, and the radius R of which depends on the following parameters:
r: a radius of a circular cross-section of the selected modelled pathway 403;
m: a growth margin of the radius r (by default, m is equal to 10%, for example); and
c: a clearance distance that depends on the path type associated with the selected modelled pathway (for example, in the case of the EWIS of an aircraft: c=25 mm for the M path type, c=37 mm for the P path type and c=50 mm for the G path type).

In the particular implementation illustrated in FIG. 4, the radius R is more specifically defined by the following formula: R=(r+r*m+c)/sin (60°).

In a particular implementation, risk areas are consecutively positioned along the entire length of the selected modelled pathway 403, and two risk areas consecutively positioned on the selected modelled pathway 403 have an overlap ranging between 40% and 60%. This ensures that a good simulation of short-circuits is provided along the entire length of the selected modelled pathway 403. For example, in the particular implementation illustrated in FIG. 4, the two spheres 401 and 402 are consecutively positioned on the selected modelled pathway 403 and have an overlap of 50%. For example, in the particular implementation illustrated in FIG. 3, the selected modelled pathway is the one referenced PW1, and spheres S1 to S9 are consecutively positioned along its entire length.

In a test step 104, the system 500 determines, for the one or each simulated short-circuit, whether at least one other modelled pathway is affected by said at least one simulated electrical short-circuit. In the aforementioned particular implementation, where the risk area is a sphere, the system 500 determines whether at least one other modelled pathway touches or is at least partially contained within the sphere.

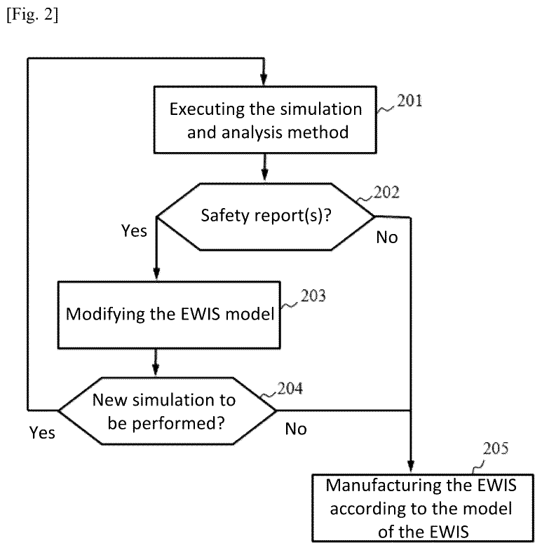

If at least one other modelled pathway is affected (positive response in the test step 104), the system 500 provides a report concerning the compliance of the EWIS in step 105, then proceeds to step 106 described hereafter. This report is intended to be used for designing and manufacturing the EWIS (see the description of FIG. 2 below). Otherwise (negative response to the test step 104), the system 500 proceeds directly to step 106 described hereafter.

The compliance report includes, for each simulated short-circuit on the selected modelled pathway, a list including, for the one or each modelled pathway affected by this simulated electrical short-circuit, the functional information associated with said affected modelled pathway. In a particular implementation, the list also includes (for example, if at least one affected modelled pathway is associated with a different path type from the path type with which the selected modelled pathway is associated), for the selected modelled pathway, the functional information associated with this selected modelled pathway.

With reference to the specific implementation illustrated in FIG. 3, in which the selected modelled pathway is the one referenced PW1, the compliance report includes, for example:
for the short-circuit simulated by the sphere S1, a list including:
   for the selected modelled pathway PW1, the functional information TLW1;
   for the affected modelled pathway PW4, the functional information TLW1 and TLW2; and
   for the affected modelled pathway PW3, the functional information TLW2;
for the short-circuit simulated by the sphere S2, a list including:
   for the selected modelled pathway PW1, the functional information TLW1; and
   for the affected modelled pathway PW3, the functional information TLW2;
for the short-circuit simulated by the sphere S3, a list including:
   for the selected modelled pathway PW1, the functional information TLW1; and
   for the affected modelled pathway PW3, the functional information TLW2;
for the short-circuit simulated by the sphere S4, a list including:
   for the selected modelled pathway PW1, the functional information TLW1;
   for the affected modelled pathway PW2, the functional information TLW3; and
   for the affected modelled pathway PW3, the functional information TLW2.

In this example, the compliance report does not include a list for the short-circuits simulated by the spheres S5 to S9 because no modelled pathway is affected by these simulated electrical short-circuits.

In the test step 106, the system 500 determines whether another modelled pathway needs to be analysed. If so (positive response in the test step 106), the system 500 performs a new iteration of steps 102 to 106, selecting this other modelled pathway to be analysed in step 102. If not (negative response in the test step 106), the system 500 proceeds to the final step 107.

FIG. 2 schematically illustrates an example of an algorithm for designing and manufacturing an electrical wiring interconnection system for a given vehicle, in one embodiment. This algorithm is at least partly executed by the computer (data processing system comprising electronic circuitry), reference 500 in FIG. 5.

In a step 201, the system 500 executes the algorithm of FIG. 1 described above (method for simulating and analysing at least one electrical short-circuit in an EWIS of a vehicle), applying it to the EWIS of this given vehicle. The 3D digital model of the EWIS used in step 101 of FIG. 1 is called “current 3D digital model”.

In a test step 202, the system 500 determines (automatically or via a human-machine interface) whether the execution of step 201 results in the provision of at least one report concerning the compliance of the EWIS.

If the answer to the test step 202 is positive, the system 500 proceeds to step 203, in which it modifies (automatically or via a human-machine interface) the current 3D digital model according to the one or more compliance reports, in order to acquire a modified 3D digital model. For example, each item of functional information listed in the report (and therefore considered lost) is reassigned (reassociated) to a modelled pathway that is not affected by the one or more simulated short-circuits. In the real physical world, this is equivalent to transferring the physical signal modelled by this functional information to another physical cable pathway.

After step 203, the system 500 proceeds to the test step 204, in which it determines (automatically or via a human-machine interface) whether a new simulation needs to be performed, i.e., whether a new iteration of steps 201 to 204 needs to be performed using the modified 3D digital model (which becomes the new current 3D digital model). If so (positive response in the test step 204), the system 500 performs this new iteration of steps 201 to 204. If not (negative response in the test step 204), the system 500 proceeds to step 205.

In the event of a negative response in the test step 202, the system 500 proceeds directly to step 205.

In step 205, a manufacturer manufactures the EWIS for the given vehicle, based on the modified 3D digital model, in the event of a positive response in the last iteration of the test step 202, or based on the current (unmodified) 3D digital model in the event of a negative response in the last iteration of the test step 202.

In an alternative implementation, the test step 204 is omitted and a new iteration of steps 201 to 203 is systematically performed (replacing the current 3D digital model with the modified 3D digital model) following the execution of step 203.

FIG. 5 schematically illustrates an example of the hardware architecture of a computer 500 (or data processing system comprising electronic circuitry), which comprises, connected by a communication bus 510: a processor or CPU (Central Processing Unit) 501; a RAM (Random Access Memory) 502; a read-only memory ROM 503, for example, a Flash memory; a data storage device, such as a hard disk drive HDD, or a storage media reader, such as an SD (Secure Digital) card reader 504; at least one communication interface 505.

The processor 501 is capable of executing instructions loaded into the RAM 502 from the ROM 503, from an external memory (not shown), from a storage medium (such as an SD card) or from a communication network (not shown). When the data processing system 500 is powered up, the processor 501 is capable of reading instructions from the RAM 502 and of executing them. These instructions form a computer program causing the processor 501 to implement the behaviours, the steps and the algorithms described above (notably in relation to FIGS. 1 to 4).

All or some of the behaviours, the steps and the algorithms described above thus can be implemented in software form by executing a set of instructions via a programmable machine, such as a DSP (Digital Signal Processor) or a microcontroller, or can be implemented in hardware form via a dedicated machine or component (chip) or a dedicated set of components (chipset), such as an FPGA (Field-Programmable Gate Array) or an ASIC (Application-Specific Integrated Circuit). In general, the computer 500 comprises electronic circuitry arranged and configured to implement the behaviours, the steps and the algorithms described above.

1. A method for designing and manufacturing an electrical wiring interconnection system for a vehicle, comprising:
a) implementing, by means of a computer, a method for simulating and analysing at least one electrical short-circuit, the simulation and analysis method being applied to said electrical wiring interconnection system of said vehicle and comprising:
A) acquiring a 3D digital model of the electrical wiring interconnection system of the vehicle, the digital model comprising modelled pathways that are 3D objects each modelling a physical pathway of one or more cables of the electrical wiring interconnection system, each modelled pathway being associated with one or more functional items of information each modelling a physical signal that passes through said modelled pathway;
B) selecting one of the modelled pathways;
C) simulating at least one electrical short-circuit on the selected modelled pathway;
D) determining, for each simulated short-circuit, whether at least one other modelled pathway is affected by the simulated electrical short-circuit; and
E) if at least one other modelled pathway is affected, providing a report concerning the compliance of the electrical wiring interconnection system of the vehicle, the compliance report including, for each simulated short-circuit on the selected modelled pathway, a list including, for the one or for each modelled pathway affected by said simulated electrical short-circuit, the one or more items of functional information associated with said affected modelled pathway;
b) if the implementation of the method for simulating and analysing at least one electrical short-circuit results in the provision of at least one report concerning the compliance of the electrical wiring interconnection system of the vehicle, modifying the 3D digital model of the electrical wiring interconnection system of the vehicle according to said at least one compliance report, with each functional item of information listed in the at least one compliance report being reassociated with a modelled pathway that is not affected by the at least one simulated short-circuit; and
c) manufacturing the electrical wiring interconnection system of the vehicle according to the modified 3D digital model if a modification has been made to the 3D digital model, or according to the unmodified 3D digital model if no modification has been made to the 3D digital model.

2. The method according to claim 1, wherein at least one new iteration of operations B) to E) is performed, with a different selected modelled pathway.

3. The method according to claim 1, wherein the list also includes, for the selected modelled pathway, the one or more functional items of information associated with the selected modelled pathway.

4. The method according to claim 1, wherein simulating a given electrical short-circuit on the selected modelled pathway comprises: positioning a risk area encompassing part of the selected modelled pathway,
and wherein determining, for the given simulated short-circuit, whether at least one other modelled pathway is affected by said at least one simulated electrical short-circuit comprises: determining whether at least one other modelled pathway touches or is at least partially contained in the risk area.

5. The method according to claim 4, wherein the risk area is a sphere, the centre of which is positioned at the centre of a circular cross-section of the selected modelled pathway, and the radius R of which depends on the following parameters:
r: a radius of a circular cross-section of the selected modelled pathway;
m: a growth margin of the radius r; and
c: a clearance distance that depends on a path type associated with the selected modelled pathway.

6. The method according to claim 4, wherein two risk areas consecutively positioned on the selected modelled pathway have an overlap ranging between 40% and 60%.

7. The method according to claim 1, wherein, if a modification has been made to the 3D digital model, a new iteration of operations a) and b) is performed before manufacturing the electrical wiring interconnection system of the vehicle.
